(19) United States
(12) Patent Application Publication
(10) Pub. No.: US 2008/0224474 A1
(43) Pub. Date: Sep. 18, 2008

(54) Fluid engine

(76) Inventor: Justice Daniel Boisselle, Harrah, WA (US)

Correspondence Address: Justice Boisselle, 2811 Stephenson Rd., Harrah, WA, 98933, US

(21) Appl. No.: 11/716,730

(22) Filed: Mar. 12, 2007

(51) Int. Cl. F03B 1/00; H02K 53/00

(52) U.S. Cl. 290/54; 74/DIG. 9

(57) ABSTRACT

The fluid engine has one or more wheels that are turned by water. There is a shaft that goes through the turbine(s). On one end of the shaft is a generator on the other is the torque output. A pump is located at the top of the turbine housing.

### CROSS-REFERENCE TO RELATED APPLICATIONS

not applicable

### FEDERALLY SPONSORED RESEARCH

not applicable

### SEQUENCE LISTING OR PROGRAM

not applicable

### BACKGROUND OF THE INVENTION

This invention pertains to the field of perpetual energy machines

1. Prior Art

Current engines consume fuel and are costly to run. They also emit carbon monoxide and other harmful gasses including greenhouse gases. They cause smogs and overheat. In cold weather they can be hard to start.

2. Objects and Advantages

The fluid engine saves our fuel reserves as it doesn't burn fuel. It conserves energy and doesn't emit harmful gasses. The hydro engine costs nearly nothing to operate.

### SUMMARY

The fluid engine runs by a fluid hitting on one or more turbines at a high pressure. As it hits the turbine it turns a shaft that runs though the turbines.

### DRAWINGS

not applicable

### DETAILED DESCRIPTION—PREFERRED EMBODIMENT

The turbine(s) is(are) enclosed in a closed housing. The turbine(s) is(are) enclosed in a closed metal housing. There is a a shaft connecting all of the turbines if there is more than one. The housing is 1 in. off of the turbine(s). The nozzle for spraying the water is ⅙ as high as it is long. There is a pump is located at the top of the turbine(s).

Operation

The fluid is pumped out of the bottom of the turbine housing and is sprayed at the turbine at a high pressure. The fluid has an antifreeze solution added. Electricity needed for starting is stored in a battery. A generator is turned by one end of the shaft. The other end is the torque output. The generator provides all the electricity needed for the engine. If there is extra power it will charge the battery.

Conclusion, Ramifications, and Scope

The fluid engine uses no fuel so it will conserve our valuable fuel reserves. It doesn't eject harmful gasses or drip motor oil. It saves money because the owner doesn't have to pay for fuel.

This invention can be used in a automobile or the power source for a power plant. It can be used as a energy source on anything that requires energy in the form of torque. Said inventions scope shouldn't be determined by the description, but the claims.

1. An engine, comprising of:
(a) one or more turbine(s) that is(are) turned by a pressurized liquid hitting it(them),
(c) a shaft running through said turbine(s),
(d) said shaft being a torque output
(e) a case the said turbine(s) are enclosed in.
